(19) United States
(12) Patent Application Publication
(10) Pub. No.: US 2002/0133352 A1
(43) Pub. Date: Sep. 19, 2002

(54) Sound exchanges with voice service systems

(76) Inventors: Stephen John Hinde, Bristol (GB); Robert Francis Squibbs, Bristol (GB)

Correspondence Address: LOWE HAUPTMAN GOPSTEIN, GILMAN AND BERNER LLP, SUITE 310, 1700 DIAGONAL ROAD, ALEXANDRIA, VA, 22314

(21) Appl. No.: 10/005,875

(22) Filed: Dec. 7, 2001

(30) Foreign Application Priority Data
Dec. 9, 2000 (GB) 0030079.8

(51) Int. Cl. G10L 21/00

(52) U.S. Cl. 704/270.1

(57) ABSTRACT

A sound service system participates in a multi-turn sound exchange with a human user, this sound exchange involving one or more cycles in each of which the service and user take turns to provide a noise or utterance the form or content of which is already public. The service system preferably also participates in normal voice dialog exchanges with the human user, the service system using a respective manager for the normal voice dialogs and the multi-turn sound exchanges with control passing between the two managers as required, each manager when in control effecting this control according to a corresponding script.

### FIELD OF THE INVENTION

The present invention relates to sound exchanges with voice service systems.

### BACKGROUND OF THE INVENTION

In recent years there has been an explosion in the number of services available over the World Wide Web on the public internet (generally referred to as the “web”), the web being composed of a myriad of pages linked together by hyperlinks and delivered by servers on request using the HTTP protocol. Each page comprises content marked up with tags to enable the receiving application (typically a GUI browser) to render the page content in the manner intended by the page author; the markup language used for standard web pages is HTML (Hyper Text Markup Language).

However, today far more people have access to a telephone than have access to a computer with an Internet connection. Sales of cellphones are outstripping PC sales so that many people have already or soon will have a phone within reach where ever they go. As a result, there is increasing interest in being able to access web-based services from phones. ‘Voice Browsers’ offer the promise of allowing everyone to access web-based services from any phone, making it practical to access the Web any time and any where, whether at home, on the move, or at work.

Human-to-human sound interaction is, in fact, far richer than the simple dialogs currently possible through the use of scripted voice service systems.

It is an object of the present invention to provide a method and system which enhances the available forms of sound interaction with a voice service system.

### SUMMARY OF THE INVENTION

According to one aspect of the present invention, there is provided a method of interacting with a human user through a sound service system, wherein the service system participates with the human user both in normal voice dialog exchanges, and in a multi-turn sound exchange the form and content of which are pre-specified and already public, this sound exchange involving one or more cycles in each of which the service and user take turns to provide a noise or utterance with the appropriate pre-specified content.

According to another aspect of the present invention, there is provided a method of interacting with a human user through a sound service system, wherein the service system participates in a multi-turn sound exchange with the user, this sound exchange involving one or more cycles in each of which the service and user take turns to provide a noise or utterance the form or content of which is already public.

According to a further aspect of the present invention, there is provided a sound service system comprising a sound input channel for receiving and interpreting sound input signals, a sound output channel for generating sound output signals, and a dialog manager connected to an output of the sound input channel and an input of the sound output channel, the dialog manager being operative to manage the participation of the service system in exchanges with a user and comprising:

means for managing participation of the service system in normal voice dialog exchanges with the user, and

means for managing participation of the service system in a multi-turn sound exchange with the user, the form and content of this exchange being pre-specified and already public, and the exchange involving one or more cycles in each of which the service and user take turns to provide a noise or utterance with the appropriate pre-specified content.

According to a still further aspect of the present invention, there is provided a A sound service system comprising a sound input channel for receiving and interpreting sound input signals, a sound output channel for generating sound output signals, and a dialog manager connected to an output of the sound input channel and an input of the sound output channel, the dialog manager being operative to manage the participation of the service system in exchanges with a user and comprising:

means for managing participation of the service system in normal voice dialog exchanges with the user, and

means for managing participation of the service system in a multi-turn sound exchange with the user, the form and content of this exchange being pre-specified and already public, and the exchange involving one or more cycles in each of which the service and user take turns to provide a noise or utterance with the appropriate pre-specified content.

### BRIEF DESCRIPTION OF THE DRAWINGS

A method and system embodying the invention, for multi-turn sound exchanges with a sound service system, will now be described, by way of non-limiting example, with reference to the accompanying diagrammatic drawings, in which:

FIG. 1 is a diagram of a sound service system for effecting multi-turn dialog exchanges;

FIG. 2 is a diagram showing the sounds exchanged between a human user and the service system in respect of a first multi-turn sound exchange;

FIG. 3 is a diagram showing the sounds exchanged between a human user and the service system in respect of a second multi-turn sound exchange;

FIG. 4 is a diagram showing the sounds exchanged between a human user and the service system in respect of a third multi-turn sound exchange; and

FIG. 5 is a diagram showing a voice browser system including both a voice dialog manager and a multi-turn dialog manager.

### BEST MODE OF CARRYING OUT THE INVENTION

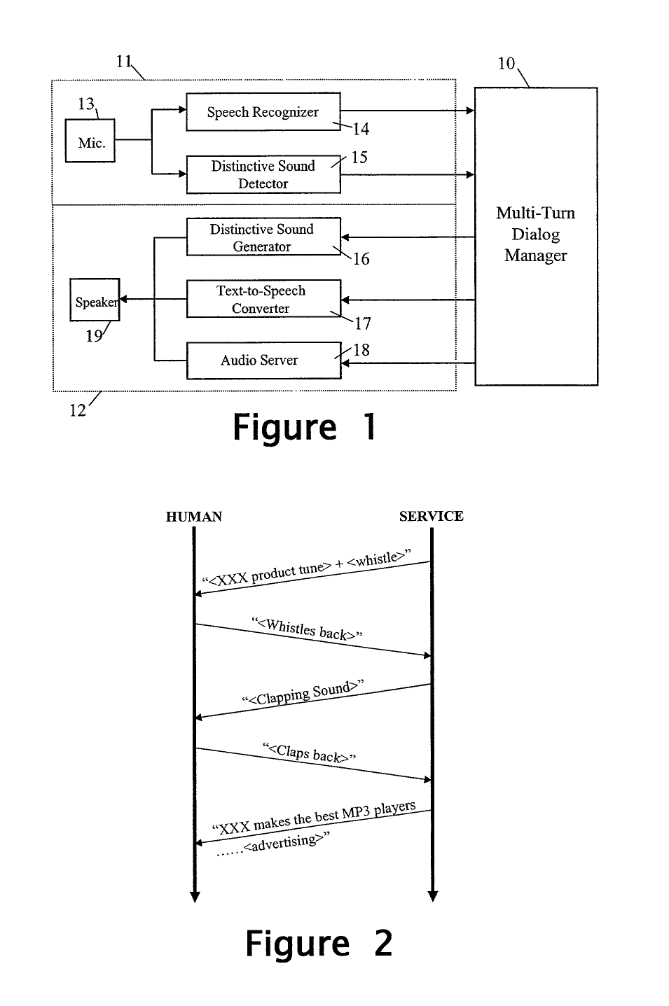

FIG. 1 shows a sound service system for participating in a multi-turn sound exchange with a human user, this sound exchange involving one or more cycles in each of which the service and user take turns to provide a noise or utterance. Generally the form or content of the noise or utterance will already be public and known to the user so that they can participate fully in the exchange and gain a feeling of involvement.

The FIG. 1 service system comprises a sound input channel 11 for receiving and interpreting sound inputs, a sound output channel 12 for generating sound output, and a multi-turn dialog manager 10 connected to the output side of the sound input channel 11 and the input side of the sound output channel 12. The sound input channel comprises a microphone 13 feeding a speech recogniser 14 and a distinctive sound detection unit 15, this latter unit being designed to recognise specific non-word sounds such as handclaps and whistles. The sound output channel 12 comprises a distinctive sound generator 16 for generating non-word sounds such as handclaps and whistles, a text-to-speech converter 17, an audio server 18 for outputting pre-recorded sound segments, and loudspeaker 19 for receiving the outputs of the generator 16, converter 17 and server 18 and generating corresponding sounds. The multi-turn dialog manager 10 is operative to manage the participation of the service system in a multi-turn sound exchange, commanding the units of the output channel to generate appropriate sounds during the systems turn's in the multi-turn dialog and using the input channel to check for appropriate responses from the user. The multi-turn dialog manager 10 is, for example, arranged to interpret script files that define respective multi-turn dialogs.

FIG. 2 illustrates a first multi-turn dialog, in this case initiated by the manager 10. The dialog proceeds as follows:

| | |
|---|---|
| Service: | “<XXX product tune> + <whistle>” |
| Human: | “<whistles back>” |
| Service: | “<Clapping sound>” |
| Human: | “<Claps>” |
| Service: | “XXX makes the best MP3 players . . .<advertising>” |

The distinctive sound generator 16 is used to generate the whistle and clap for the service system turns whilst the distinctive sound detection 15 unit detects these sounds repeated back by the human user. The TTS converter 17 is used for generating the spoken words “XXX makes the best MP3 players”. The audio server 18 is used to generate the XXX product tune and possibly also the advertising material (though this could be scripted for the TTS converter).

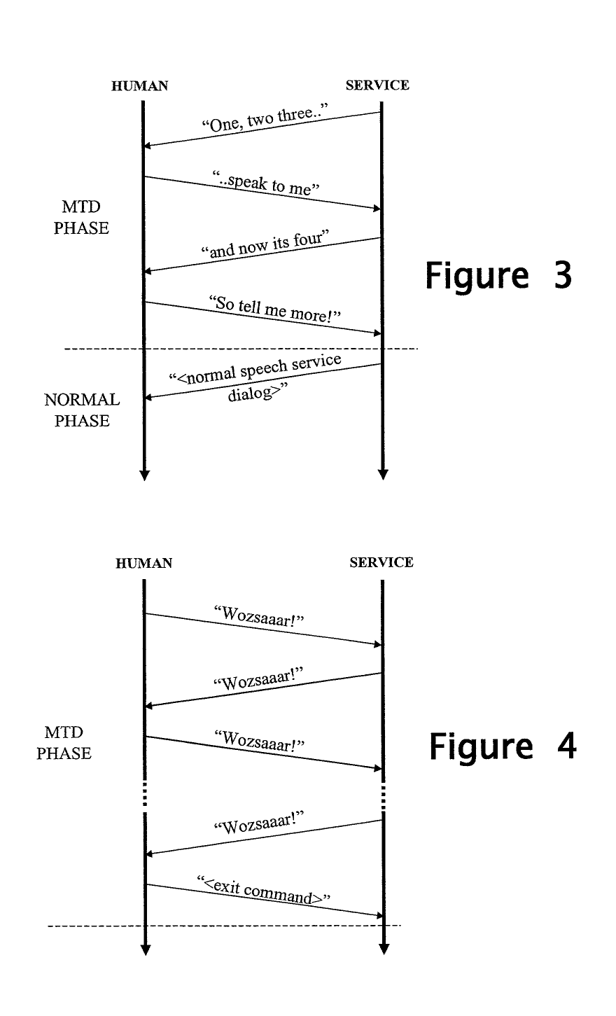

FIG. 3 depicts a wholly speech-based multi-turn dialog running as follows:

| | |
|---|---|
| Service: | “One, Two, Three . . .” |
| Human: | “Speak to me!” |
| Service: | “And now its four . . .” |
| Human: | “So tell me more!” |
| Service: | <enters a normal dialog mode> |

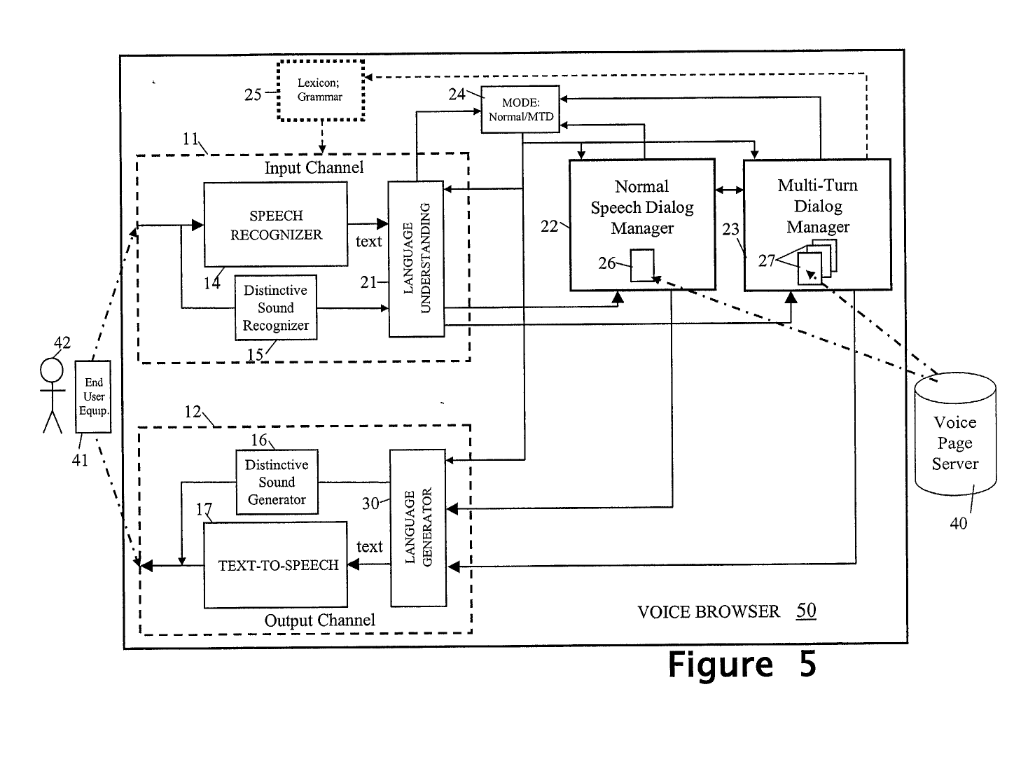

The multi-turn dialog actually terminates after the second human response. In the present case, the service system now changes to a normal voice dialog mode under the control of a voice dialog manager which can either be combined into one functional block with the multi-turn dialog (MTD) manager 10, or embodied in a separate functional block (not shown in FIG. 1 but to be more fully described hereinafter with respect to the embodiment of FIG. 5).

The multi-turn dialogs illustrated in FIGS. 2 and 3 were both initiated by the MTD manager 10 (for example, upon the user first contacting the service system). However, the user may also initiate the dialog by uttering or otherwise generating the first sound elements of the first turn of the dialog, this first turn being, now, a user turn. In this case, the MTD manager 10 recognizes these first sound elements and participates in the corresponding multi-turn dialog.

FIG. 4 depicts a multi-turn dialog started by the user saying the word “wozsaar!” (in other words: “What's up” meaning “What is happening?”). This is repeated back by the service and this cycle the loops (repeats) either for as long as the user is willing to continue or until a timeout period, or turn count, expires. In the illustrated case, the user ends the multi-turn dialog by uttering an exit key word causing the service system to drop into a normal voice dialog mode.

FIG. 5 shows a voice browser 50 provided with multi-turn dialog capability. Voice browser 50 is located in the communications infrastructure (being, for example, provided by a PSTN or PLMN operator or by an ISP). A voice browser allows people to access the Web using speech and is interposed between equipment 41 of a user 42, and a voice page server 40. This server 40 holds voice service pages (text pages) that are marked-up with tags of a voice-related markup language (or languages). When a normal voice dialog page (such as page 26) is requested by the user 42, it is interpreted at a top level (dialog level) by a voice dialog manager 22 of the voice browser 33 and output intended for the user is passed in text form to the output channel 12 of the browser. The output channel is here shown as comprising a language generator 30 for driving a Text-To-Speech (TTS) converter 17 and a distinctive sound generator 16. The output of channel 12 is passed over a sound connection (such as a telephone voice circuit or VoIP connection) to the user equipment 41. User voice (and other sound) input is passed back over this connection to an input channel 11 of the voice browser. The input channel in this case comprises a speech recognition unit 14 and a distinctive sound detection unit 15, both feeding a language understanding unit 21. The input channel 11 uses lexicon and grammar data 25 to determine what sounds/words have been received and may seek to understand this input in the context of what has gone before. For normal voice dialog operation, the output of the channel 11 is passed to the voice dialog manager 22 which then determines what action is to be taken according to the received input and the directions in the original page.

The voice browser 50 further comprises a MTD manager 23 that is a distinct functional element from the normal voice dialog manager 22, the MTD manager operating according to one or more multi-turn dialog scripts 23. The scripts are, for example, loaded into the MTD manager 23 when the voice browser first contacts a voice website hosted on server 40, these scripts being retained whilst the voice browser remains at the same voice website (in contrast, as the browser moves between pages of the website, different scripts 26 are loaded into and out of the voice dialog manager 22).

The voice browser can operate in two modes, namely a normal voice dialog mode in which the voice dialog manager 22 is in control and runs its currently loaded script 26, and an MTD mode in which the MTD manager 23 is in control and runs a selected one of its currently loaded scripts 27. The current mode of the browser is held by mode unit 24 which indicates the current mode of the voice browser to the managers 22, 23, the language understanding unit, and the language generator 30.

When the browser is in its normal voice dialog mode, the language understanding unit 21 uses the grammar appropriate to script 26 but, in addition, is caused to look out for user input sound elements that correspond to the initial elements of any of the multi-turn dialog script starting with a user turn. If the initial elements of such a MTD script are detected in the input sound stream, the unit 21 changes the mode of the browser held by mode unit 24 to the MTD mode. As a result, MTD manager 23 assumes control of the following sound exchange which it controls in accordance with the script 27 whose initial elements were detected.

The MTD mode can also be entered by the current script 26 requesting the unit 24 to change modes, the script 26 also informing the manager 23 which multi-turn dialog script 27 is to be executed.

When the browser is in its MTD mode, the language understanding unit 21 uses the grammar appropriate to the selected script 27 but, in addition, is caused to look out for user input sound elements that correspond to exit key words or phrases indicating that the user wishes to terminate the current multi-turn dialog exchange. If an exit key word or phrase is detected in the input sound stream, the unit 21 changes the mode of the browser held by mode unit 24 to the normal voice dialog mode. As a result, voice dialog manager 22 assumes control of the following sound exchange in accordance with script 26.

The normal voice dialog mode can also be entered as a result of the MTD manager causing the unit 24 to change the set mode upon the MTD manager finishing execution of a current multi-turn dialog script 27.

During the course of execution of a multi-turn dialog script, the user's input can be treated in a number of different ways:

(a)—checked only for occurrence of a user input, not necessarily as expected;

(b)—checked for expected user input;

(c)—checked for one of several possible expected user inputs.

In respect of (b), if the expected user input is not received, the multi-turn dialog can be terminated or a correction dialog entered. In the case of (c), the identity of received input (if one of the expected inputs) can be used to determine which of several branches in the dialog is pursued by the MTD manager 23; alternatively, the identity of the received input can be used to select a particular voice dialog script 26 to be used when the normal voice 30 dialog mode is entered at the end of the current multi-turn dialog, this identity being passed to manager 22; generally, however, the multi-turn dialog will serve no function in respect of accessing or controlling the course of the normal dialog exchanges.

Many variants are, of course, possible to the arrangements described above. For example, the MTD manager can be provided with functionality for ensuring that the service system executes its next turn promptly on the conclusion of the user's turn. This functionality can include means for predicting when the user's input will terminate having regard to its speed of delivery. Such promptness of response increases the user's feeling of interaction with the service system.

Whilst the turns of the multi-turn dialogs will generally be public knowledge (that is, their form and/or content are pre-specified and not confidential), this is not always necessary to achieve a feeling of involvement. In the preferred embodiments, the multi-turn dialogs are promotional in nature, promoting a commercial enterprise and/or its goods and/or its services. The multi-turn dialogs are not, by their very nature of being public, password exchanges nor are they merely formal greetings because the user's response to a standard greeting phrase from the service (such as “Good Morning! How are you?”) can be almost anything.

It will be appreciated by persons skilled in the art that the managers 22 and 23 will normally be implements in software and can, in fact, simply be separate instantiations of the same manager class. Alternatively, the managers can be implemented as different methods of a general dialog manager object, or different software functions called as required by a controlling program.

1. A method of interacting with a human user through a sound service system, wherein the service system participates with the human user both in normal voice dialog exchanges, and in a multi-turn sound exchange the form and content of which are pre-specified and already public, this sound exchange involving one or more cycles in each of which the service and user take turns to provide a noise or utterance with the appropriate pre-specified content.

2. A method according to claim 1, wherein the multi-turn sound exchange serves no function in respect of restricting access to, or controlling the course of, the normal dialog exchanges.

3. A method according to claim 1, wherein the multi-turn sound exchange are of a promotional nature.

4. A method according to claim 1, wherein the multi-turn sound exchange is initiated by the service system.

5. A method according to claim 1, wherein the multi-turn sound exchange is initiated by the human user.

6. A method according to claim 5, wherein the multi-turn sound exchange is initiated at any time during the course of the normal dialog exchanges.

7. A method according to claim 1, wherein the service system uses the same dialog manager for the normal voice dialogs and the multi-turn sound exchanges with each being effected according to a corresponding script run by the dialog manager as required.

8. A method according to claim 1, wherein the service system uses a respective manager for the normal voice dialogs and the multi-turn sound exchanges with control passing between the two managers as required, each manager when in control effecting this control according to a corresponding script.

9. A method according to claim 8, including the step of the user inputting a sound corresponding to the start of a particular multi-turn sound exchange whilst the voice dialog manager is in control, the service system recognising this sound and putting the multi-turn dialog manager in control to run the script corresponding to said particular multi-turn sound exchange.

10. A method according to claim 9, wherein the service system is adapted to recognise and distinguish between sounds corresponding to multiple different multi-turn sound exchanges.

11. A method according to claim 8, including the step of the user inputting a sound, whilst the multi-turn dialog manager is in control, indicative that the user wishes to exit the current multi-turn sound exchange, the service system recognising this sound and putting the voice dialog manager in control to run an appropriate voice dialog script.

12. A method according to claim 8, wherein the scripts for the voice dialog manager and multi-turn dialog manager are independently loaded.

13. A method according to claim 8, wherein the voice service system comprises a voice browser for interpreting scripts provided by voice sites hosted by page servers, one or more multi-turn sound exchange scripts being loaded to the multi-turn dialog manager upon a user first contacting a said voice site and remaining loaded whilst the user browses the voice pages of the site, the currently-visited voice page of the site being loaded to the voice dialog manager.

14. A method according to claim 1, wherein the multi-turn sound exchange includes, or is constituted by, non-word sounds.

15. A method according to claim 1, wherein the multi-turn sound exchange is of a looping nature and terminates in response to at least one of:
explicit user request;
timeout of a predetermined time from commencement of the exchange;
execution of a preset number of cycles.

16. A method according to claim 1, wherein the user's input during at least one turn of the multi-turn sound exchange, is used to determine which of two or more branches in the service system's part of the multi-turn sound exchange is taken by the service system.

17. A method according to claim 1, wherein the user's input during at least one turn of the multi-turn sound exchange, is used to determine the identity of a voice dialog script followed by the service system following termination of the multi-turn sound exchange.

18. A method of interacting with a human user through a sound service system, wherein the service system participates in a multi-turn sound exchange with the user, this sound exchange involving one or more cycles in each of which the service and user take turns to provide a noise or utterance the form or content of which is already public.

19. A sound service system comprising a sound input channel for receiving and interpreting sound input signals, a sound output channel for generating sound output signals, and a dialog manager connected to an output of the sound input channel and an input of the sound output channel, the dialog manager being operative to manage the participation of the service system in exchanges with a user and comprising:
means for managing participation of the service system in normal voice dialog exchanges with the user, and
means for managing participation of the service system in a multi-turn sound exchange with the user, the form and content of this exchange being pre-specified and already public, and the exchange involving one or more cycles in each of which the service and
user take turns to provide a noise or utterance with the appropriate pre-specified content. in a multi-turn sound exchange with a human user that involves one or more cycles in each of which the service and user take turns to provide a noise or utterance the form or content of which is already public.

20. A sound service system according to claim 19, wherein the multi-turn sound exchange serves no function in respect of restricting access to, or controlling the course of, the normal dialog exchanges.

21. A sound service system according to claim 19, wherein the multi-turn sound exchange are of a promotional nature.

22. A sound service system according to claim 19, wherein the dialog manager includes initiation means for initiating a multi-turn sound exchange under the control of the corresponding said means for managing, the initiation means being operative to initiate a multi-turn sound exchange in response to an input by the human user made at any time during the course of a said normal voice dialog exchange.

23. A sound service system comprising:
a sound input channel for receiving and interpreting sound input signals;
a sound output channel for generating sound output signals,
a voice service manager connected to the output side of the sound input channel and the input side of the sound output channel, the voice service manager serving to manage normal voice dialog interactions with a human user;
a multi-turn dialog manager connected to the output side of the sound input channel and the input side of the sound output channel, the multi-turn dialog manager being operative to manage the participation of the service system in a multi-turn sound exchange with a human user that involves one or more cycles in each of which the service and user take turns to provide a noise or utterance; and
a changeover controller for switching control between the voice service manager and the multi-turn dialog manager.

24. A sound service system according to claim 23, wherein the multi-turn sound exchange serves no function in respect of restricting access to, or controlling the course of, the normal dialog exchanges.

25. A sound service system according to claim 23, wherein the multi-turn sound exchange are of a promotional nature.

26. A sound service system according to claim 23, wherein the changeover controller is operative, whilst the voice dialog manager is in control, to recognise user input of a sound corresponding to the start of a particular multi-turn sound exchange, and to thereupon cause the multi-turn dialog manager to assume control and participate in said particular multi-turn sound exchange.

27. A sound service system according to claim 26, wherein the changeover controller is adapted to recognise and distinguish between sounds corresponding to multiple different multi-turn sound exchanges.

28. A sound service system according to claim 23, wherein the changeover controller is operative, whilst the multi-turn dialog manager is in control, to recognise user input of a sound indicative that the user wishes to exit the current multi-turn sound exchange, and to thereupon cause the voice service manager to assume control.

29. A sound service system according to claim 23, wherein the multi-turn sound exchange includes, or is constituted by, non-word sounds, the system including specific means for recognising and/ or generating said non-word sounds.
